(19) United States
(12) Patent Application Publication
(10) Pub. No.: US 2023/0015701 A1
(43) Pub. Date: Jan. 19, 2023

(54) TRAILERS WITH EV CHARGING CAPACITY

(71) Applicant: The Aluminum Trailer Company, Nappanee, IN (US)

(72) Inventors: Rakesh Katkuri, Peddapalli Telangana (IN); Shashidhar Suryanarayana Channarayapatna, South Bend, IN (US); Shane Doehrmann, South Bend, IN (US); Christopher Handgen, Goshen, IN (US); Ganesh Baral, Mishawaka, IN (US)

(73) Assignee: The Aluminum Trailer Company, Nappanee, IN (US)

(21) Appl. No.: 17/806,774

(22) Filed: Jun. 14, 2022

Related U.S. Application Data
(60) Provisional application No. 63/218,655, filed on Jul. 6, 2021.

(51) Int. Cl. B60L 53/51; H02J 7/02; H02J 7/00; B60L 53/53; B60P 3/07; B60R 16/04

(52) U.S. Cl. CPC B60L 53/51; H02J 7/02; H02J 7/0013; B60L 53/53; B60P 3/07; B60R 16/04; H02J 2207/20; H02J 2300/26; B60L 2210/30; B60L 2210/14

(57) ABSTRACT

Disclosed are multiple embodiments of a trailer, and more specifically car and toy haulers for transporting a secondary EV vehicle such as a car, snowmobile or ATV and simultaneously provide EV charging capacity for the toy vehicle. The trailer is capable of recharging EV vehicle when parked and/or when in transit. The trailer includes an intelligent EV charging system to accept and control multiple power inputs. The EV charging system can convert the power from various types of power inputs and store the power within an on-board power bank. The EV charging system can also output power from the power bank to an EV vehicle in a fast or rapid charging manner.

### FIELD OF DISCLOSURE

The present disclosure relates in general to trailers, and specifically deals with trailers such as towable trailers for hauling vehicles and/or recreational vehicles capable of charging electric vehicles.

### BACKGROUND

Recreational vehicles (RVs) are vehicles designed as temporary living quarters for recreational, camping, travel or seasonal use. Two main categories of RVs exist: motorized motorhomes and towable trailers, the latter of which can be towed behind a vehicle. Types of towable trailers may include folding camping trailers, expandable trailers, conventional travel trailers and fifth-wheel travel trailers.

Some trailers are known as toy haulers or car haulers. A car hauler is capable of hauling other vehicles, namely cars. A toy hauler is capable of hauling other vehicles, colloquially known as toys, for example cars, motorcycles, all-terrain vehicles, snowmobiles, etc. Various car and toy haulers have an enclosed hauling space and a separate living space. Traditionally, cars and toys have been gasoline powered. When the car or toy runs out of gasoline, a spare fuel tank is needed in order to refuel and continue using the vehicle. As the world becomes more energy conscious, alternatives to non-sustainable energy sources, such as gasoline, have become more common. Due to this desire to pivot to sustainable energy sources, many vehicles, including cars and such toys, are now being designed to be electrically powered rather than to run on gasoline. Electrically powered vehicles are commonly referred to using an EV designation. Electric power is available from many different sources. It is desirable for an RV to be able to charge an EV car or toy with electrical power collected from multiple power sources.

Additionally, trailers often travel to locations without easy access to traditional energy sources or sources for efficiently charging an EV. Therefore, there is a desire for trailers to be capable of charging EV vehicles in locations without easy access to other energy sources.

Thus, there is a need for improvement in this field.

### SUMMARY

The present disclosure involves multiple embodiments of trailers, and more specifically towable trailers for hauling or transporting an electrically powered secondary EV vehicle such as a car, snowmobile or ATV and also providing EV charging capacity.

The trailer may be capable of recharging the secondary EV vehicle when parked or in transit. The trailer includes an intelligent EV charging system mounted to the trailer chassis to accept and control multiple power inputs. The EV charging system can receive power from a variety of power inputs. The EV charging system can detect the type of power it is receiving from an unput. The EV charging system may receive and detect more than one power input at a time. THE EV charging system may recognize when an EV vehicle is connected and in need of charging. In this situation, the EV charging system directs the power from the power input to the EV vehicle. If a vehicle is not connected or is not in need of charging, the EV charging system may direct power to a power bank for storage. The EV charging system can convert the power received from the various types of power inputs to power suitable for storage within the power bank. The EV charging system can also output power from the power bank to an EV vehicle in a fast or rapid charging manner and through one or more connection interfaces (such as J1722, CHAdeMO, CCS1, CCS2, Mennekes and Tesla®) as may be desired.

The power inputs may be different electrical types, including solar power, shore power, generator power and DC power. The electrical inputs may be high voltage or low voltage and may be AC or DC sources. The EV charging system is configured to intelligently accommodate all types of power inputs.

The EV charging system includes a power bank, for instance a 125 kWh battery array. In certain embodiments, the power bank is mounted below floor level between two axles to provide enhanced stability to the trailer as well as to reduce heat from exposure of the power bank to the sun. The power bank can be integrated with a cooling unit, reducing the risk that the power bank may overheat. The power bank is used for EV charging and may also power various appliances or systems within the trailer.

In some versions, the trailer includes an array of one or more solar panels. The solar panels may be fixed to the top of the trailer's roof. The trailer may further include inclined solar panels on the side walls of the trailer that may be hinged and optionally moved or actuated based on the position of the sun for optimum efficiency. The solar panels may be removable and may be stored in a storage compartment within the trailer, for instance during transport.

Further forms, objects, features, aspects, benefits, advantages, and embodiments of the present disclosure will become apparent from a detailed description and drawings provided herewith.

### BRIEF DESCRIPTION OF THE DRAWINGS

FIG. 1 is a cross-sectional, perspective view of an trailer with a vehicle inside it.

FIG. 2 is a rear view of an embodiment of the hauling space of the trailer of FIG. 1 without a vehicle.

FIG. 3 is a perspective view of the trailer of FIG. 1 with a vehicle located adjacent to the trailer.

FIG. 4 is a perspective view of an trailer with solar panels deployed.

FIG. 5 is a perspective view of an alternate embodiment of an trailer with solar panels deployed.

FIG. 6 is an enlarged view of a representative storage cabinet for storing removable solar panels in the trailer of FIG. 1.

FIG. 7 is a bottom view of the trailer of FIG. 4.

FIG. 8 is a bottom view of the trailer of FIG. 1.

FIG. 9 is a schematic detailing the relationship between one or more power input sources, a control system, a power bank and power output to an EV vehicle.

FIG. 10 is a schematic further detailing the relationship between one or more power input sources, a control system, a power bank and power output to an EV vehicle or a trailer and demonstrating the components of the control system in more detail.

FIG. 11 is a perspective view another embodiment of an trailer.

FIG. 12 is a perspective view of another embodiment of an trailer.

FIG. 13 is a perspective view of another embodiment of an trailer in the form of a car hauler.

FIG. 14 is a perspective view of another embodiment of an trailer.

FIG. 15 perspective view of the trailer of FIG. 14 with a side wall removed.

FIG. 16 is an exploded view of an EV vehicle support surface of the trailer of FIG. 14.

FIG. 17 is a rear view of an embodiment of the hauling space of the trailer of FIG. 14.

FIG. 18 is a top view of the trailer of FIG. 14 with an elevated surface removed.

### DESCRIPTION OF THE SELECTED EMBODIMENTS

For the purpose of promoting an understanding of the principles of the disclosure, reference will now be made to the embodiments illustrated in the drawings and specific language will be used to describe the same. It will nevertheless be understood that no limitation of the scope of the disclosure is thereby intended. Any alterations and further modifications in the described embodiments, and any further applications of the principles of the disclosure as described herein are contemplated as would normally occur to one skilled in the art to which the disclosure relates. Certain embodiments of the disclosure are shown in great detail, although it will be apparent to those skilled in the relevant art that some features that are not relevant to the present disclosure may not be shown for the sake of clarity.

The present disclosure includes various representative embodiments of trailers including but not limited to RVs. As used herein, representative trailers are towable car and toy haulers. However, it is understood that many of the features disclosed herein may have applications in any type of trailer/vehicle hauling trailer. An RV trailer typically includes an enclosed hauling space and a separate enclosed living space. A toy hauler may be used for transporting an auxiliary vehicle colloquially referred to as a “toy.” A vehicle is an “EV vehicle” herein if it has an electrically powered drive motor for at least partially propelling the vehicle. Non-limiting examples of an EV vehicle include a car, scooter, snowmobile or ATV. Often, an EV vehicle needs to be charged or recharged in an efficient manner so that the EV vehicle is ready for use at a destination. The trailer is capable of charging EV vehicle when parked or in transit.

The trailer includes an intelligent EV charging system mounted to the trailer chassis to receive and distribute power from a plurality of power source inputs. The power source inputs may be different electrical types, including solar power, shore or utility power, generator power and DC power. The electrical inputs may be high voltage or low voltage and may be alternating current (AC) or direct current (DC) sources. The EV charging system can receive and convert the power from various types of power inputs to store the power within a power bank mounted to the trailer chassis. The EV charging system can output power from the power bank via at least one power output to an EV vehicle in a fast or rapid charging manner. Optionally, electrical energy from the EV charging system may also be used to power various other systems or appliances in the trailer.

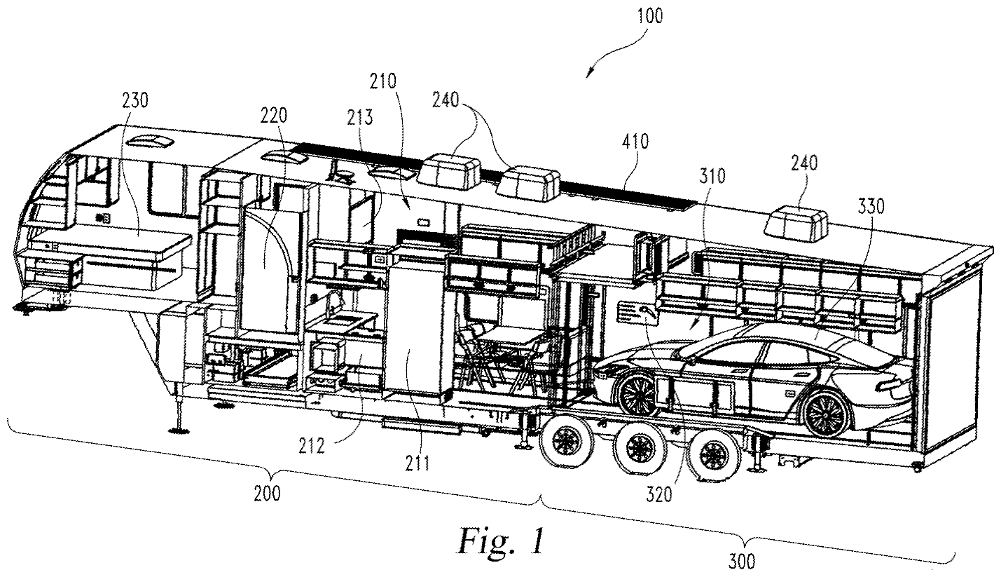

FIG. 1 illustrates a cross-sectional, perspective view of a representative trailer 100. The trailer 100 may include a living space 200 and a hauling space 300. As representative examples, the living space 200 may include one or more of a kitchen and dining/living area 210, a bathroom 220 and a bedroom 230. The living space 200 may include various amenities/utilities to make the trailer 100 more luxurious and comfortable. It is understood that an trailer may be customized to include any combination of desired amenities within an offering of amenities that a consumer may desire. For example, the kitchen and dining/living area 210 may include a refrigerator and freezer 211, an electric cook top and oven 212, lights (not shown), outlets (not shown), a television 213 and stereo system (not shown). The trailer 100 may include a heating, ventilation and air conditioning (HVAC) system. The HVAC system may include a plurality of air conditioning units 240.

Hauling space 300 may define an open chamber 310 for storing and transporting a secondary EV vehicle within the trailer. The open chamber 310 may be defined by four walls, a floor and a ceiling to fully enclose the open chamber 310. One of the four walls may physically separate the hauling space 300 from the living space 200. The wall separating the hauling space from the living space may include a door or opening to move between the two spaces without having to exit the trailer. In some embodiments, there may not be a wall physically separating the hauling space 300 from the living space, or there may be a wall including a window (not shown). The rear wall is a door configured to be movable or hinged and allowing the EV vehicle to enter or exit the trailer. Optionally, a trailer may include a fold down door with a lower hinge that turns into a ramp, one or two horizontally swinging doors or a roll up door. A separate ramp may be necessary if a swinging door or roll up door is utilized. Other door options, including a side exit arrangement having a hoist or other mechanism for loading and unloading the toys, are contemplated herein.

The hauling space includes a charging station 320 as an output terminal for the EV charging system of the trailer 100. The charging station 320 may include electric charging connectors 322, such as a cable and a charger plug, that may be removably connected to an EV vehicle 330 in the open chamber 310 to charge the battery of the EV vehicle 330. One or more typical connection interfaces, such as J1722, CHAdeMO, CCS1, CCS2, Mennekes and Tesla® as several non-limiting examples, may be provided as connectors 322. In another form, a single connector 322 may be provided with various adapters to accommodate the various types of charging interfaces utilized by EV vehicles.

In one form, the charging station 320 provides DC power output to charge the EV vehicle 330. Preferably the charging station 320 provides an output that is a fast or rapid charging DC system for electric vehicles. For example, the charging system may provide an output of 50-500 V direct current or 200-750 V direct current, eliminating the need for conversion and providing DC power directly to the battery of the EV vehicle 330. In some preferred embodiments, the charging system may provide an output of 240 V or 480 V.

In some embodiments, the charging rate of the electric vehicle is 3.7-7.0 kW/h. In other fast or rapid charging embodiments, the charging rate of the electric vehicle is 50 kW/h or higher. The charging time for the battery of the EV vehicle will depend on the type of EV vehicle and, in particular, the charging interface, its maximum charge rate, the type and size of battery used by the EV vehicle, the EV vehicle's current state of charge, and other environmental conditions.

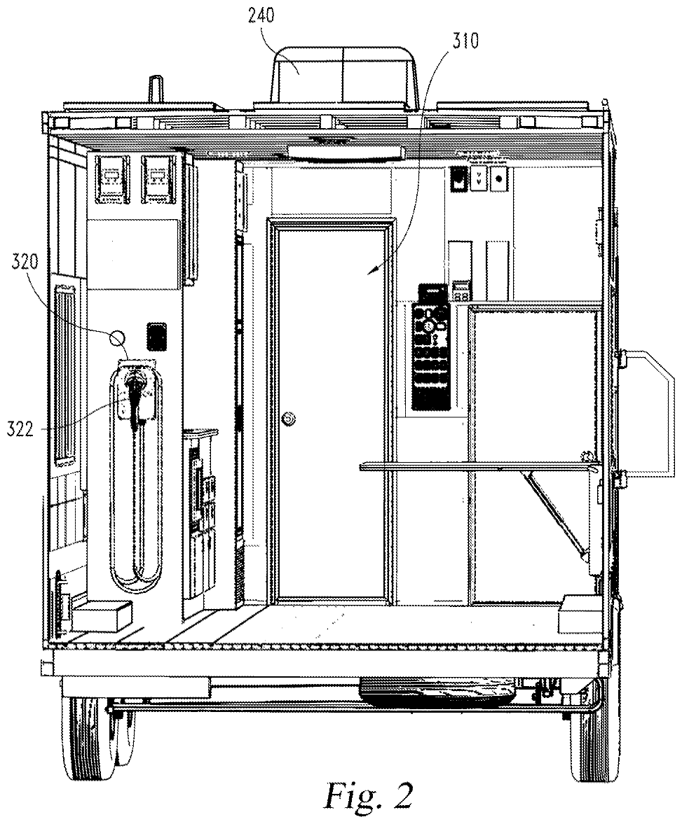

FIG. 2 illustrates another embodiment of the hauling space 300. This embodiment includes identical or similar components with a different layout. It is understood that the charging station 320 may be located wherever is most convenient for a user's needs or to address other concerns.

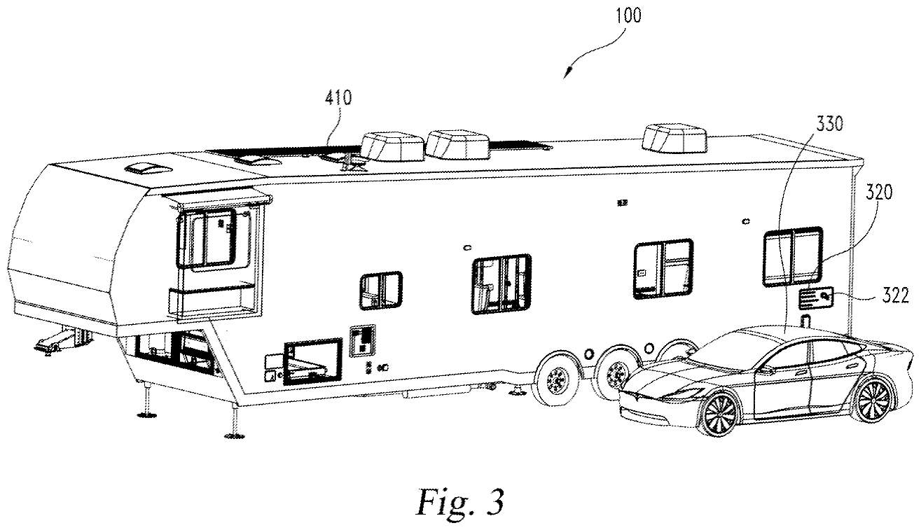

FIG. 3 illustrates the exterior of trailer 100 with an EV vehicle 330 parked adjacent to the trailer 100. The trailer 100 may include a charging station 320 accessible on the exterior of the trailer 100 to charge EV vehicles 330 parked near the trailer 100. In some embodiments, a charging station 320 may include multiple electric charging connectors 322. One charging connector 322 may be located inside the hauling space 300 while a second charging connector 322 may be on the exterior of the trailer to allow charging of an EV vehicle located inside or outside the trailer. In other embodiments, an trailer 100 may include a charging station 320 within the hauling space 300 as disclosed above and another charging station 320 accessible from the exterior of the trailer 100. An electric charging connector 322 located on the exterior portion of the trailer may be removed or retracted into the trailer and covered when not in use, such as during transit. In another form, a charging station 320 located on the interior may have a charging connector 322 of sufficient length to enable it to reach the charging port of an EV vehicle parked alongside the trailer 100. One or more access panels may be provided on the exterior of the trailer 100 for this purpose or the rear door may be utilized.

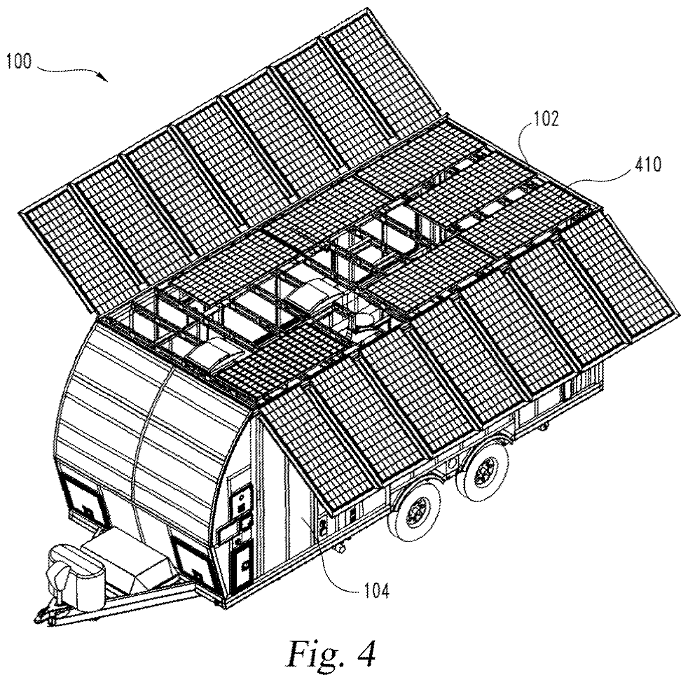

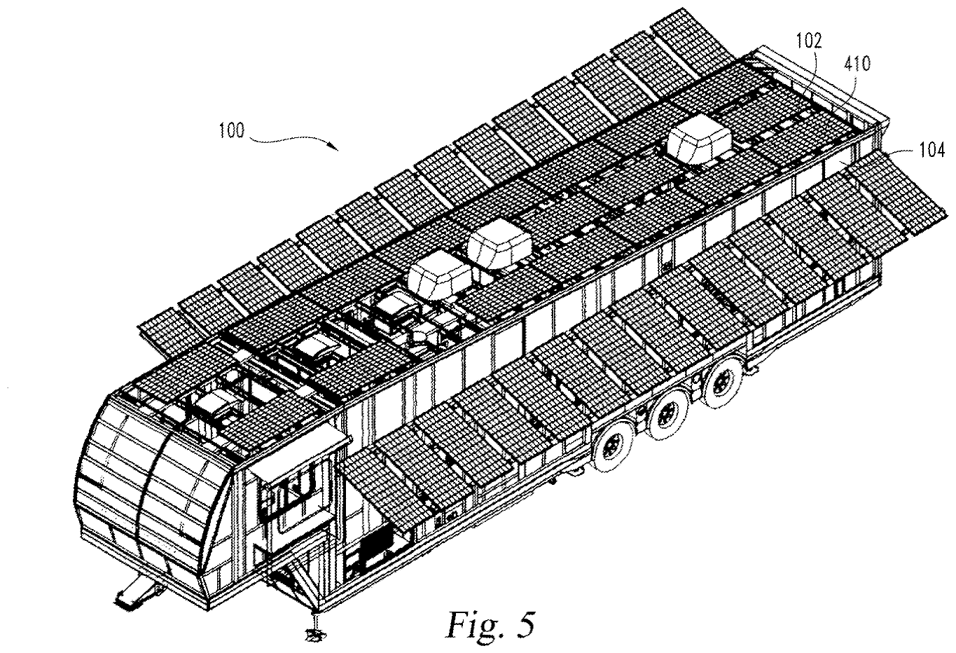

As seen in FIGS. 1 and 3, but illustrated in greater detail in FIGS. 4 and 5, trailer 100 may include a plurality of solar panels 410. Some of the solar panels 410 may be secured/fixed to the roof 102 of the trailer 100. The solar panels 410 located on the roof 102 may be affixed flat atop the roof or capable of being angled in order to optimize the angle of the panels 410 to the sun. Other solar panels 410 may be attached and angled off the side walls 104 of the trailer 100. In some embodiments, the angled solar panels 410 extend in a cantilevered angle off the side of the trailer 100 over the surface/ground. The solar panels 410 are used to gather solar energy when parked or in transit to charge a power bank 500 and/or to charge the batteries of the EV vehicles stored in the trailer 100. The solar panels 419 are mechanically mounted to the trailer and connected electrically to power the power bank 500 (described below) of the trailer 100.

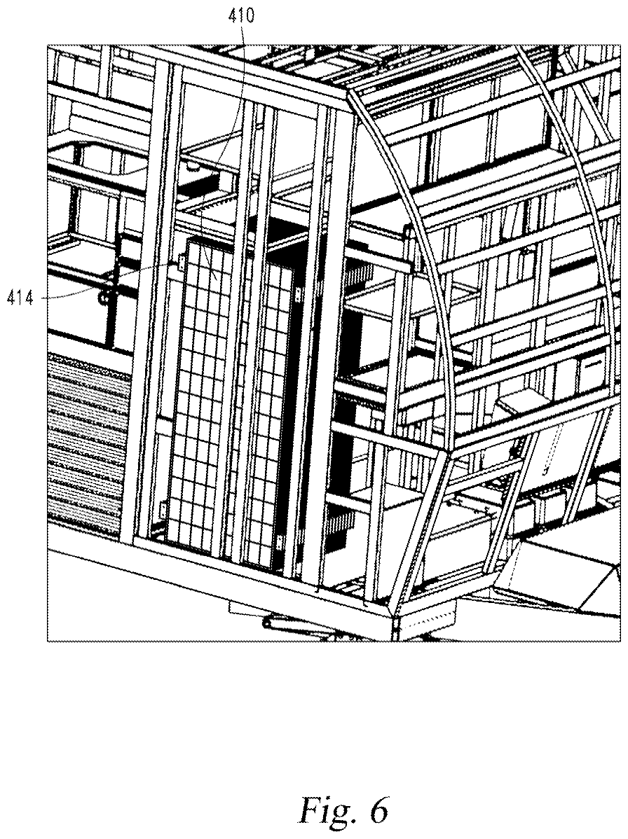

Certain angled solar panels may be attachable and detachable from the trailer. When the angled solar panels are not in use, they may be detached from the trailer and stored within a storage cabinet 414. In one embodiment, the solar panels 410 are inserted into the storage cabinet 414 in a stacked configuration (as illustrated in FIG. 6).

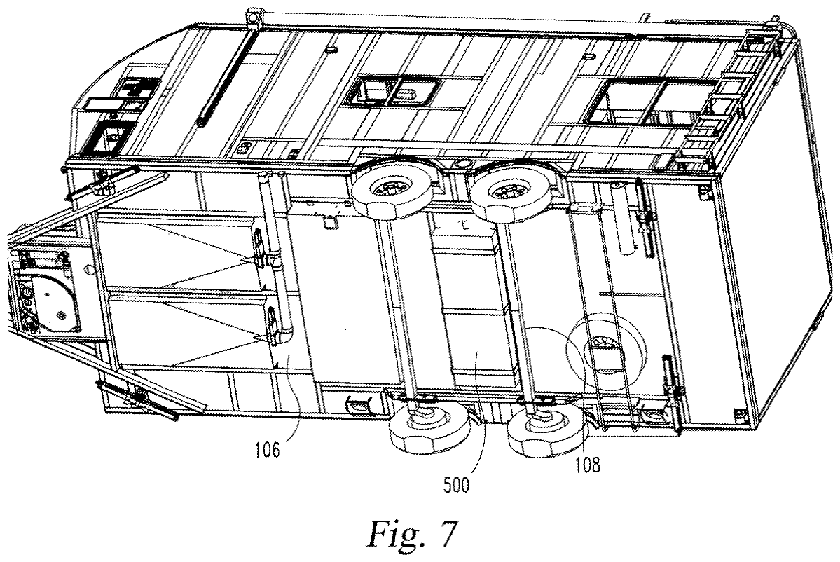

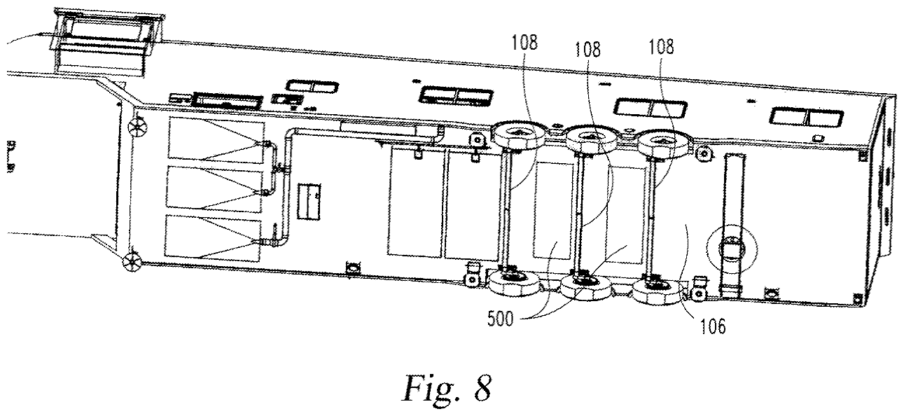

FIG. 7 and FIG. 8 illustrate two embodiments of an underside 106 of an trailer 100. As illustrated, the EV charging system includes the storage battery/power bank 500, for instance a 125 kWh lithium ion power bank. The battery bank can be mounted in many locations across the trailer 100. In one preferred embodiment, the power bank is mounted below floor level and spaced between two axles 108 to provide a low center of gravity and a balanced weight load. In certain forms, the power bank 500 is either partially or fully enclosed within a reinforced frame or compartment, such as a steel frame or box, in order to maintain the structural integrity of the power bank 500 during an accident or other potentially damaging situation. The power bank 500 may include one or more batteries. In one form a lithium ion battery may have a maximum voltage output of 339 V. However, it is understood that multiple batteries may be configured within the power bank 500 to achieve and/or increase the voltage output if desired for fast charging capabilities. When using conventional lithium ion batteries to form the power bank 500, in some embodiments, 12 cells are used per cell row with 17 cell rows. It is understood that any applicable battery or array of batteries may be used for this system.

The power bank 500 may be mounted between two axles 108 for effective load balancing and stability. Optionally, the power bank 500 can be integrated with a cooling unit (not shown), reducing the risk that the power bank 500 may overheat. A cooling unit is desirable when using lithium ion batteries that are more susceptible to overheating, both to protect the batteries from overheating as well as to prolong their useful life. The power bank 500 is used for storing electrical power from the power input sources for electric vehicle charging. In one form, the power bank 500 has a minimum voltage output of at least 200 V.

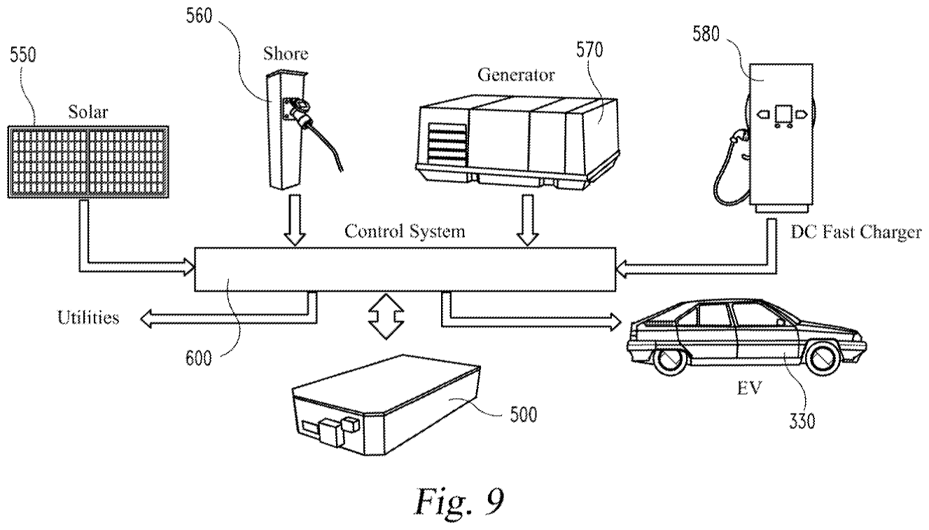

FIG. 9 illustrates a basic schematic diagram of the EV charging system. EV charging system includes a control system 600 operably connected to the power bank, the power source inputs, and the power output. As illustrated, the EV charging system is designed to make use of one or more power source inputs to charge the power bank 500. The EV charging system may also direct the one or more power inputs to directly charge an EV vehicle. In some preferred embodiments, the power bank capacity may be 125 kWh. In other embodiments, the power bank capacity can be an appropriate level higher or lower than 125 kWh. The one or more power inputs include a solar power source 550 (solar panels 410), a shore power source 560 (AC power), a generator 570 (AC power) and/or a DC source 580 which are routed through control system 600.

Solar power/energy is available from the plurality of solar panels 410 mounted on the trailer as described above. The solar panels use sunlight to generate direct current electricity and direct the energy generated to the power bank 500. Solar panels generally generate low voltage DC power. Depending on the amount of available sunlight, the solar panels may produce at least 210 W per panel per hour. Depending on the solar panel used, the watts produced per hour can be higher. The solar power generated by solar panels 410 is stored, when capacity is available, within power bank 500 as dictated by the battery management function of control system 600.

In some embodiments, a portable generator 570 may be mounted within the trailer 100. In other embodiments, the portable generator 570 may be located or placed externally to the trailer. Alternately, a fixed external generator could be connected to the power system. The generator 570 may provide power to the power bank 500 or directly to a trailer system or appliance drawing electrical power. A generator 570 will typically supply either 120 V or 240 V AC power. The AC power produced by generator 570 is stored, when capacity is available, within power bank 500 as dictated by the battery management function of control system 600. In addition, due to the nature of the AC power, an AC/DC converter (not shown) within control system 600 may be utilized. This AC/DC converter is bypassed when DC power is supplied, such as from solar panels 410 or DC sources, as described below.

In certain embodiments, the power system may be charged using an external fast or rapid charge DC source 580, for instance as available from an external EV fast or rapid charging station. The DC source 580 may provide fast or rapid charging capabilities at 240 V or 480 V. The DC power from the DC source 850 is stored, when capacity is available, within power bank 500 as dictated by the battery management function of control system 600.

The power system may also be charged using shore power. The shore power may be provided by an external alternating current (AC) source 560. The shore power source may be an electrical outlet for instance at 120 V or 240 V AC. The AC power produced by AC source 560 is stored, when capacity is available, within power bank 500 after passing through the AC/DC converter as dictated by the battery management function of control system 600.

The control system 600 is designed to be an intelligent unit to make decisions regarding power inputs from different sources, convert the power into the desired DC power of the power bank 500 and distribute that power to satisfy the trailer's energy needs. As demonstrated in FIG. 9, the one or more power inputs are routed through the control system 600. The control system 600 either routes the power to an EV vehicle 330 that is plugged in and/or to the power bank 500 for storage.

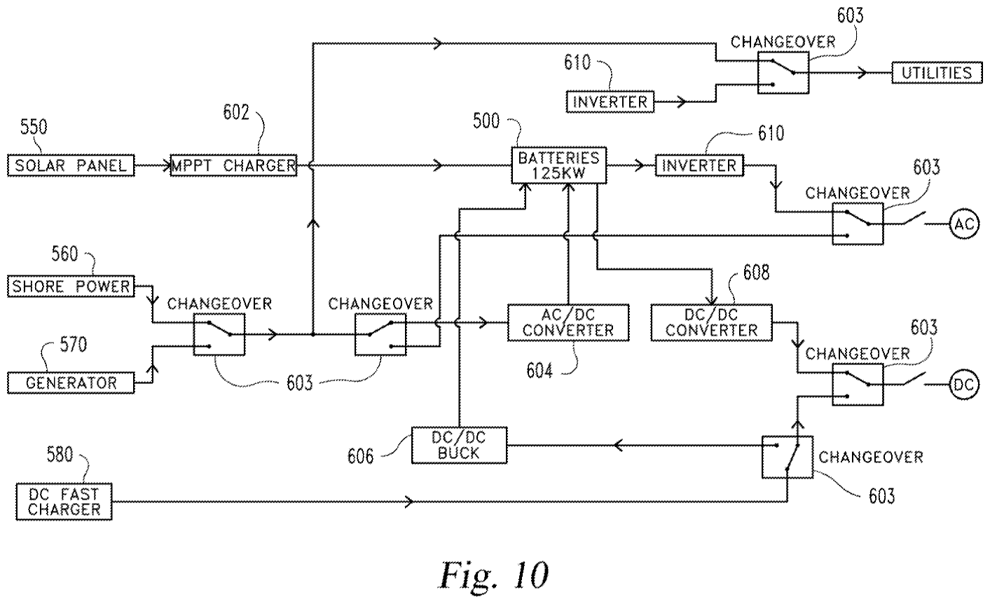

The EV charging system is illustrated in further detail in FIG. 10. The control system 600 may encompass a combination of various components operably connected. The control system may include memory and programming for storing the operating instructions for the control software and logic software. The control system further includes a processor with a control unit and logic unit to direct the control system to carry out or execute the programming. The control unit and logic unit may control the direction of electrical power provided from the input sources directly to an electric vehicle or to the power bank 500. The logic unit also controls if a power source needs to be converted from AC to DC. Additionally, the control system controls voltage conversion from a higher voltage to a lower voltage or from a lower voltage to a higher voltage.

Associated with the solar panels 410, the control system 600 includes a maximum power point tracker (MPPT) charger 602. The MPPT charger 602 acts as a regulator between the solar panels 410 and the power bank 500. The MPPT charger 602 converts a higher DC power output from the solar panels 410 to a high-frequency AC, and then converts it back to a different, lower DC voltage and current that can charge and be stored by the power bank 500. The MPPT charger 602 ensures that the power bank 500 is charged correctly by the solar panels and assists in preventing over charging. The MPPT charger 602 may increase the effectiveness of the solar panels 410 by about 30%. In short, the MPPT charger 602 converts the solar power from the solar panels 410 from a higher voltage DC power to a lower voltage needed to charge the power bank 500.

As illustrated, the control system 600 may include a plurality of changeover switches 603. The switches are used to direct power between the various power sources, the power bank and power outputs. For example, as seen in FIG. 10, a changeover switch 603 may be located between the shore power source 560 and the generator 570 to switch between the AC power input sources being inputted at 120 V or 240V into the EV charging system. The shore power or generator power is then either directed straight to the electric vehicle/toy 330 or routed to an AC/DC converter 604 to convert the AC power into DC power capable of charging the power bank 500. Alternately, the shore power may be directed as AC power to other systems or appliances on the trailer.

In one form, the control system 600 may include a DC/DC buck (step-down) converter 606 to handle power from a high voltage input fast charging DC source 580. The input from the DC source 580 is routed through the DC/DC buck converter 606. The buck converter 606 steps down the voltage from the DC source 580 to a reduced voltage capable of safely charging the power bank 500. Alternately a changeover switch may direct the DC power directly to an EV charging station for an EV vehicle.

As demonstrated in FIG. 10, when desired the power bank 500 supplies power to a charging station for an EV vehicle 330. A DC/DC boost converter 608 steps up the DC voltage supplied by the power bank to supply high voltage DC power to a fast charging station/power output.

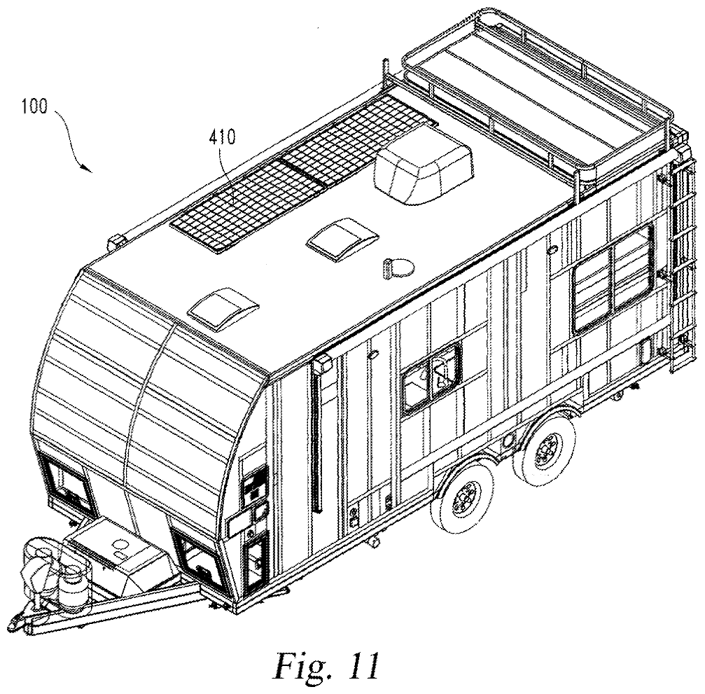

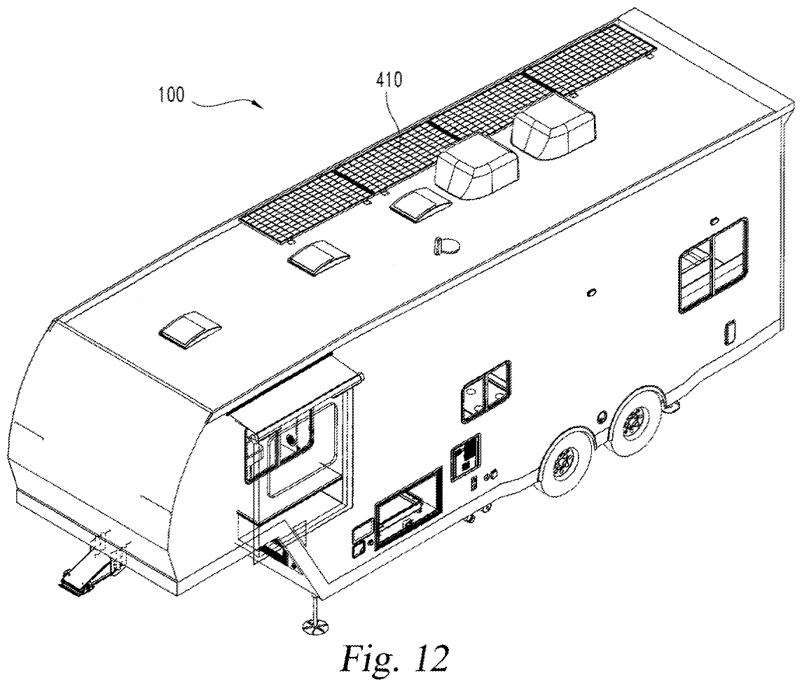

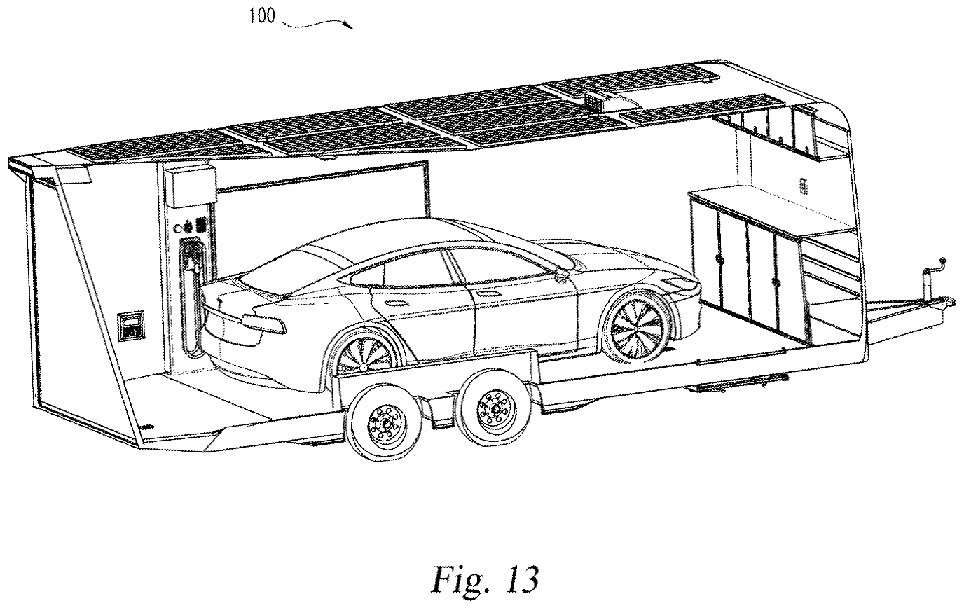

FIGS. 11-13 illustrate various embodiments of an trailer including a bumper pull model (FIG. 11), a fifth wheel model (FIG. 12) and a car hauler (FIG. 13). As disclosed, the various features are equally applicable to all trailer models.

In some embodiments, if desired, the amenities/utilities of the trailer may be powered by the one or more power input sources or the power bank 500. The EV charging system may include an inverter connected to the power bank and an AC outlet to provide power from the power bank to amenities on the trailer.

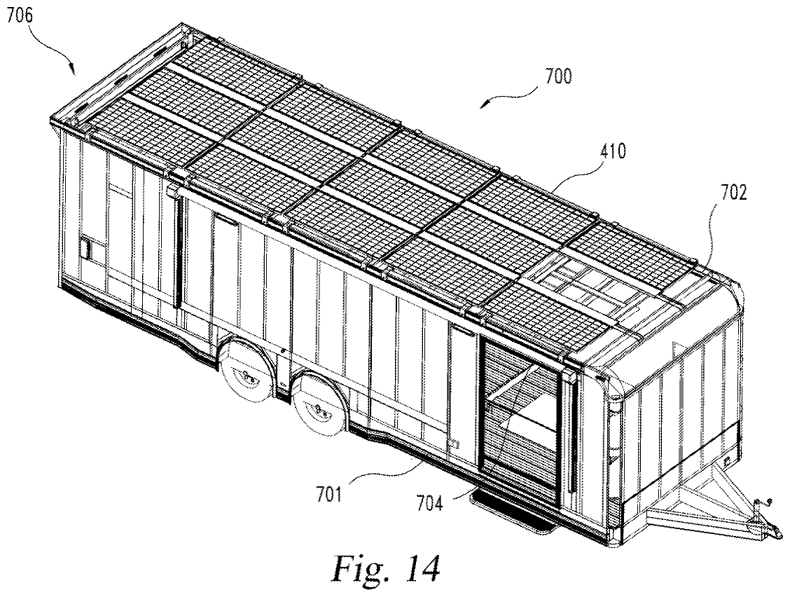

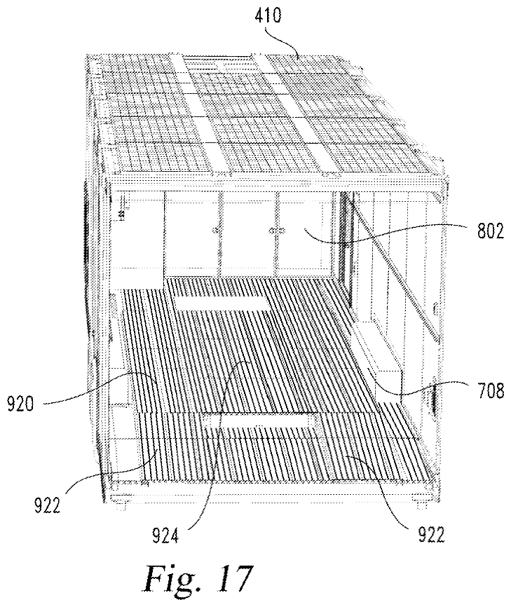

Representatively illustrated in FIGS. 14-17 is another embodiment of an trailer 700, specifically a towable car hauler. The trailer of FIGS. 14-17 includes many similarities to the trailers discussed in relation to FIGS. 1-13. All of the disclosure related to FIGS. 1-13 is incorporated herein relative to the embodiment illustrated in FIGS. 14-17. Only the differences between the embodiments illustrated in FIGS. 1-13 and FIGS. 14-17 will be discussed with relation to the embodiment illustrated in FIGS. 14-17.

FIG. 14 illustrates a perspective view of trailer 700. Similar to previously described embodiments, trailer 700 is a towable trailer with solar panels 410 secured to the roof 702 of trailer 700. trailer 700 may include side door 704 for access to the interior of trailer 700.

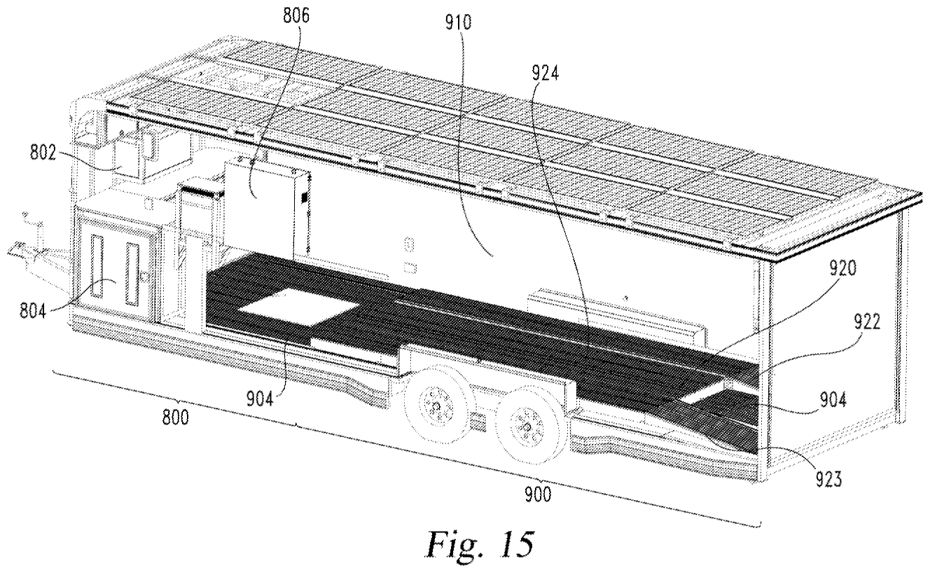

FIG. 15 illustrates a cutaway, perspective view of trailer/vehicle hauling trailer 700. trailer 700 may include a trailer chassis 701 define a living facilities 800 and/or a hauling space 900. In some embodiments, the living space and hauling space may be fully or partially enclosed. As representative examples, living facilities 800 may include cabinets 802, a generator (not shown), often stored in generator box 804, and a control panel 806 for controlling the intelligent EV charging system of trailer 700. In some embodiments, side door 704 provides access to living facilities 800.

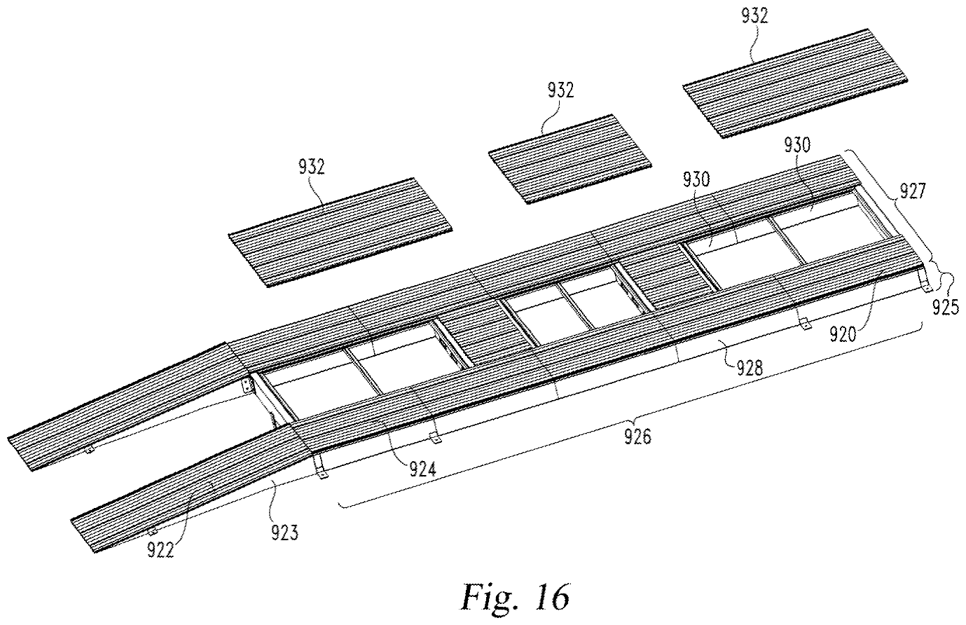

Hauling space 900 may define an open chamber 910 for storing and/or transporting a secondary EV vehicle, such as a car, within trailer 700. In some embodiments, open chamber 910 may be defined by four walls, a floor, and a ceiling. One of the four walls may physically separate the hauling space 900 from the living facilities 800. In other exemplary embodiments, as illustrated, there may not be a wall separating the living facilities 800 from the hauling space 900, resulting in one continuous open space. Another of the four walls may be a rear door 706, for example a fold down door with a lower hinge that turns into a ramp, one or two horizontally swinging doors or a roll up door. A separate ramp may be necessary if a swinging door or roll up door is utilized. Rear door 706 defines an opening 708 (FIG. 16) into the interior of the trailer.

Turning to FIGS. 15-18, hauling space 900 may include an EV vehicle support surface 920 for storing an EV vehicle. EV vehicle support surface 920 may include a ramp portion 922 and an elevated surface 924. EV vehicle support surface 920 may be a retrofit ancillary option/add-on to the chassis of a standard trailer 700. The add-on allows an EV vehicle to be stored, transported and/or charged within trailer 700. In some embodiments, the ramp portion 922 may include two inclined, ramped surfaces spaced apart to accommodate the space between a vehicle's wheels, allowing the vehicle to be driven, pushed, or rolled onto the elevated surface 924 for storage and/or transport. In other embodiments, the ramp portion 922 may be one single inclined surface with a width wide enough to accommodate the space between a vehicle's wheels, allowing the vehicle to be driven, pushed, or rolled onto elevated surface 924 for storage and/or transport. The ramp portion(s) 922 may include side walls 923 to support the ramps.

Elevated surface 924 is a surface with a height 925. In some embodiments, the height of the elevated surface 924 is higher than the floor 904 of the rest of living facilities 800 and hauling space 900. In other words, one would have to step down from elevated surface 924 to the floor area of living facilities 800. The length 926 and width 927 of the elevated surface provides enough surface area to store an EV vehicle on top of elevated surface 924. In some embodiments, elevated surface 924 includes a width 927 smaller than the space between two wheels on a vehicle, such that the vehicle may be placed in trailer 700 with the wheels on either side of elevated surface 924. Elevated surface 924 may also include side walls 928 to support the elevated surface 924. Side walls 928 are configured to brace against any lateral force. Side walls 928 also help brace the elevated surface from deflecting side to side. Additional, diagonal walls (not illustrated) may be used under the elevated surface to help brace the elevated surface 924. Elevated surface and EV vehicle support surface 920 in general may be made of any suitable material, such as aluminum or steel. In some embodiments, elevated surface 924 can support up to 6,500 lbs. In other embodiments, the elevated surface may support up to 6,000 pounds.

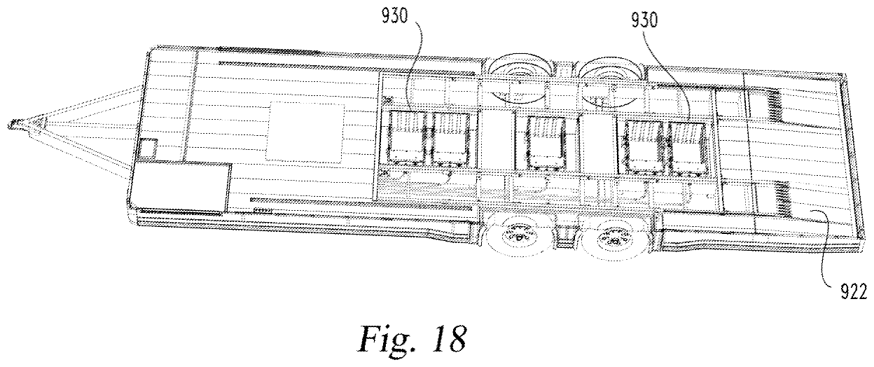

Vehicle support surface 920 and the trailer chassis define at least one storage compartment 930. As illustrated in FIGS. 16 and 18, with the elevated surface removed, at least a portion of elevated surface 924 may extend over and cover storage compartments 930. In some embodiments, elevated surface may include covers 932. In some embodiments, each storage compartments 930 is used to store a power source, such as the storage battery/power bank 500. In some embodiments, the power source is a battery, for example the batteries disclosed above. In other embodiments, more than one battery may be placed in each storage compartment 930. In the illustrated embodiment, trailer 700 includes five storage compartments 930. In the illustrated embodiment, two storage compartments 930 may be located toward the front of the trailer 700, one storage compartment may be located in the middle of trailer 700, and two storage compartments may be located toward the rear door of the trailer 700. This arrangement allows battery placement for weight distribution. In some exemplary embodiments, trailer 700 may include four batteries. The combination of the four batteries may have a storage capacity of 60 kWh. It is understood that any reasonable number of batteries may be used.

If a user opts for the trailer without EV charging, EV vehicle support surface 920 may be removed and storage compartments 930 may be used for storage. If the EV vehicle support surface 920 is removed, the floor of the hauling space 900 may be lower and/or it may be even with the floor of the living facilities 800. When used for storage, the storage compartments may include covers, for example a removable lid/cover.

It is appreciated that in some circumstances trailer 100 and trailer 700 can operate as a mobile power station/generator, for example in disaster situations. In these situations the power output can be switched to transfer power to a building. The power may be outputted as AC power, DC power or both.

While the disclosure has been illustrated and described in detail in the drawings and foregoing description, the same is to be considered as illustrative and not restrictive in character, it being understood that only the preferred embodiment has been shown and described and that all changes, equivalents, and modifications that come within the spirit of the disclosures defined by following claims are desired to be protected. All publications, patents, and patent applications cited in this specification are herein incorporated by reference as if each individual publication, patent, or patent application were specifically and individually indicated to be incorporated by reference and set forth in its entirety herein.

What is claimed:

1. A vehicle hauling trailer comprising:
a trailer chassis defining a hauling space with a support surface for storing an EV vehicle;
an EV charging system mounted to the trailer chassis and operable to receive and distribute power within the vehicle hauling trailer including:
a power bank mounted to the trailer chassis to store power;
a plurality of power source inputs operably connected to the power bank to input power to the power bank for storage, wherein the plurality of power source inputs include at least one input to receive high voltage DC power from a DC power source and at least one input to receive AC power from an AC power source;
at least one power output operably connected to the power bank and a connector configured to connect to an EV vehicle;
a DC/DC boost converter configured to step up the DC voltage supplied by the power bank to supply high voltage DC power to the at least one power output;
a control system operably connected to the power bank, the plurality of power source inputs, and the at least one power output, wherein the control system is programmed to recognize and route power received from the plurality of power source inputs to the power bank for storage; wherein the control system controls the conversion of high voltage DC power received via the DC power input or AC power received via the AC power input to low voltage DC power suitable to charge the power bank; and
wherein on demand the control system provides high voltage DC power from the power bank to an EV vehicle via the at least one power output.

2. The vehicle hauling trailer of claim 1, wherein the EV charging system includes an inverter operably connected to the power bank and an AC power output to provide power from the power bank to amenities on the vehicle hauling trailer which use AC power.

3. The vehicle hauling trailer of claim 1, wherein the control system is operable to recognize when the EV charging system is receiving power and when an EV vehicle to be charged is connected to the at least one power output and to route power received directly to the EV vehicle.

4. The vehicle hauling trailer of claim 1, wherein the control system is operable to recognize when the EV charging system is receiving power and when an EV vehicle connected to the at least one power output is fully charged and to route power received to power bank.

5. The vehicle hauling trailer of claim 1, wherein the control system is configured to route high voltage DC power through a DC/DC buck converter to convert high voltage DC to a lower voltage DC suitable for charging the power bank.

6. The vehicle hauling trailer of claim 1, wherein the plurality of power source inputs includes a solar panel array arranged on the chassis and operably connected to the EV charging system to provide power for storage within the power bank.

7. The vehicle hauling trailer of claim 1, wherein the at least one input to receive AC power receives AC power from an external 120 V or 240 V AC power source.

8. The vehicle hauling trailer of claim 7, wherein the AC power is routed through an AC/DC converter to convert the AC power to DC power suitable to charge the power bank.

9. The vehicle hauling trailer of claim 1 wherein the at least one input to receive high voltage DC power from a DC power source receives high voltage DC power from an external EV fast or rapid charging station.

10. The vehicle hauling trailer of claim 9 wherein the plurality of power source inputs includes an AC power input to receive AC power from a portable generator.

11. The vehicle hauling trailer of claim 1, wherein the hauling space is a fully enclosed space.

12. The vehicle hauling trailer of claim 1, wherein the power bank includes four batteries operably connected.

13. A vehicle hauling trailer comprising:
a trailer chassis defining an enclosed living space and a hauling space with a support surface for storing an EV vehicle; and
an EV charging system mounted to the trailer chassis and configured to receive and distribute power within the vehicle hauling trailer;
wherein the EV charging system includes a power bank mounted to the trailer chassis to store power, wherein a plurality of power source inputs are operably connected to the power bank to input power to the power bank for storage, wherein the plurality of power source inputs include at least one input to receive high voltage DC power from a DC power source and one input to receive AC power from an AC power source; and
wherein the EV charging system is configured to recognize power received via the power source inputs, to convert the power received to low voltage DC power and to route the low voltage DC power to the power bank for storage, and wherein the EV charging system is configured to output high voltage DC power to an EV vehicle on demand.

14. The vehicle hauling trailer of claim 13, wherein the EV charging system includes an inverter operably connected to the power bank and an AC outlet to provide power from the power bank to amenities on the vehicle hauling trailer which use AC power.

15. The vehicle hauling trailer of claim 13, wherein the plurality of power source inputs includes a solar panel array arranged on the chassis and operably connected to the EV charging system to provide power for storage within the power bank.

16. The vehicle hauling trailer of claim 13, wherein the at least one input to receive AC power receives AC power from an external 120 V or 240 V AC power source.

17. The vehicle hauling trailer of claim 13 wherein the at least one input to receive high voltage DC power from a DC power source receives high voltage DC power from an external EV fast or rapid charging station.

18. A vehicle hauling trailer comprising:
a trailer chassis defining a hauling space for storing an EV vehicle;
a retrofit ancillary support surface placed within the hauling space to provide a support surface for an EV vehicle, wherein the support surface and trailer chassis define at least one storage compartment to store a power bank under the support surface;
an EV charging system configured to receive and distribute power within the vehicle hauling trailer comprising:
a power bank mounted in the storage compartment to store power;
a plurality of power source inputs operably connected to the power bank to input power to the power bank for storage, wherein the plurality of power source inputs include at least one input to receive high voltage DC power from a DC power source and at least one input to receive AC power from an AC power source;
at least one power output operably connected to the power bank and a connector configured to connect to an EV vehicle;
a DC/DC boost converter configured to step up DC voltage supplied by the power bank to supply high voltage DC power to the at least one power output;
a control system operably connected to the power bank, the plurality of power source inputs, and the at least one power output, wherein the control system is programmed to recognize and route power received from the plurality of power source inputs to the power bank for storage; wherein the control system controls the conversion of power received via the power source inputs to low voltage DC power suitable to charge the power bank; and
wherein on demand the control system provides high voltage DC power from the power bank to an EV vehicle via the at least one power output via the connector.

19. The vehicle hauling trailer of claim 18, wherein the EV charging system includes an inverter operably connected to the power bank and an AC outlet to provide power from the power bank to amenities on the vehicle hauling trailer which use AC power.

20. The vehicle hauling trailer of claim 18, wherein the control system is operable to route power received from the plurality of power source inputs directly to an EV vehicle via the at least one power output via the connector.
